(19) United States
(12) Patent Application Publication
(10) Pub. No.: US 2001/0017304 A1
(43) Pub. Date: Aug. 30, 2001

(54) LIQUID PERFUME SAMPLE

(76) Inventor: OLIVIER DE POUS, PARIS (FR)

Correspondence Address: ROCKEY MILNAMOW & KATZ, TWO PRUDENTIAL PLAZA, 47TH FLOOR, CHICAGO, IL, 60601

(21) Appl. No.: 09/341,341

(22) PCT Filed: Jan. 7, 1998
(86) PCT No.: PCT/FR98/00020

§ 371 Date: None

(30) Foreign Application Priority Data
Jan. 8, 1997 (FR) 97.00119

(51) Int. Cl. B67D 5/06; B65D 88/54

(52) U.S. Cl. 222/183; 222/321.9

(57) ABSTRACT

The invention concerns a liquid perfume sample including a product container, a pump and a thruster. The container is made of glass and has an external plastic sheath.

The present invention relates to an improved liquid perfume sample, that is to say a small device for distribution of perfume.

There are different types of samples currently on the market. It is possible to distinguish two main families, namely the containers holding a few drops of product and which are closed by a stopper, and on the other hand, samples which have a pump allowing one to distribute selectively the product contained in the sample. The present invention applies more particularly to this second type of sample.

A particularity of distributors of this type is that they are generally offered for free to the clientele for advertising purposes and are then disposed of after use. Consequently, it must be possible to manufacture and assemble the distributors of this type at the lowest possible cost while providing a reliable and effective distribution of the product and at the same time, allowing the consumer to identify clearly the product contained in the sample and its manufacturer. They should also not be reusable in order to prevent the user from reusing them once they are empty, particularly by refilling them with perfume.

Currently there are two types of sample systems with a pump.

A first sample system has a tubular bottle made of glass, the glass guaranteeing stability of the product, in this case perfume, with respect to the material of the container. This type of system has a major disadvantage in that, in order to identify the product, that is to say in order to decorate it or print the brand of the perfume, it is necessary to lacquer the glass, which, on one hand, doubles the price of the little bottle, and on the other hand, limits the colors and inscriptions which can be used.

Another type of sample system with a pump has a tubular bottle made of plastic. This solution has the advantage that it is possible to use a bottle which is colored and/or which bears an advertising inscription of any kind without additional cost. The main disadvantage of this type of sample system is that the product, in this case perfume, is in continual contact with the colored plastic material, which can present problems of color changes or olfactory problems because the plastic material is not completely inert with regard to the product. This problem is amplified all the more when the product is stored before being distributed.

Another problem which arises with sample with a pump is that they are not generally provided in advance with any security from accidental actuation, which can occur in particular when the sample is in a handbag or such.

The document FR-2 522 283 describes a rechargeable spray bottle which has fittings made of metal. It is made up of a container open on both sides, one side being closed by a pump set in, and the other of a cap which can be unscrewed. This type of device is not at all suitable for a sample. In effect, the setting is very difficult or even impossible on a neck of a very small container. In any case, it requires a special machine which is expensive. Moreover, the fact that it is rechargeable runs counter to the intention of the sample, an advertising device distributed for free and intended to be discarded after use. Finally, no device for security from accidental actuation of the pump is provided, which can give rise to leaks. A leaking problem can also arise at the site of the screw-on cap.

The present invention aims to provide a perfume sample which does not reproduce the aforementioned disadvantages.

In particular, the present invention aims to provide a perfume sample with the lowest possible cost of manufacturing and assembling, while guaranteeing correct and reliable distribution of the product as well as its identification by the user.

Another aim of the present invention is to provide such a sample which enables one to provide the device with distinctive marks making it possible to recognize it without increasing its cost of manufacturing.

Another aim of the present invention is to provide such a sample in which the product can be stored as long as desired without altering the appearance, quality or nature of the device.

The present invention also aims to provide a perfume sample which is not reusable once the container is empty.

The present invention therefore relates to a liquid perfume sample which has a container of product, a pump and a thruster, the container being produced out of glass, and in that said container has a sheath made of plastic material on the outside.

Advantageously, said container is a cylinder closed on one side and which, the other side, in a sealed manner, holds the pump by means of a snappable ring fastener.

Preferably, the sample moreover has a closing cap which, in closed position, prevents is actuation of pump (20).

Advantageously, the sheath is a cylinder closed on one side by a bottom wall.

In particular, the plastic sheath extends over the whole exterior surface of the container.

According to a particular embodiment, said container is inserted in said sheath which preferably has an air escape opening in its bottom wall in order to facilitate said insertion.

Advantageously, the pump is mounted in a nonremovable manner by means of a snappable ring fastener.

Preferably, the plastic sheath can be of any coloration which is desired and/or printed with any desired distinctive signs. Thus, the present invention enables one to provide a sample which can reproduce a mark or any other distinctive sign, such as a particular color, so that it can be recognized and identified easily by the public, without increasing the cost of manufacturing.

Other characteristics and advantages of the present invention will appear more clearly in the course of the following detailed description of a particular embodiment of the invention given as a nonlimiting example with regard to the appended drawings in which:

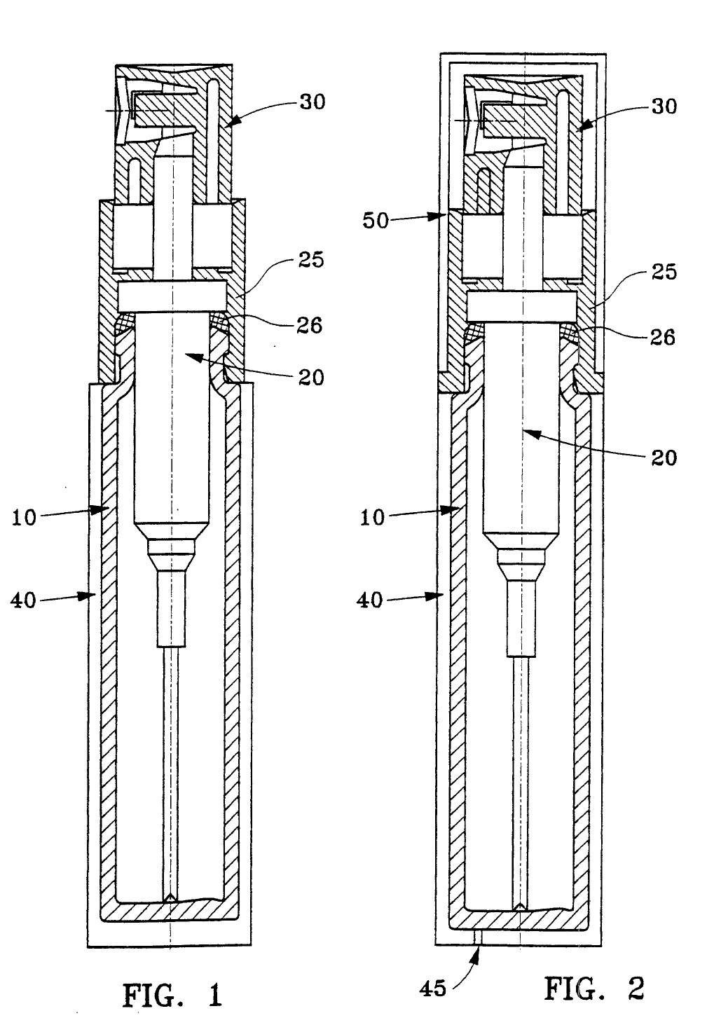

FIG. 1 represents a diagrammatic view in vertical section of a perfume sample according to the invention; and

FIG. 2 is a view similar to that of FIG. 1, representing a variant of the sample according to the invention.

In reference to the figures, the sample has container 10 on which pump 20 is mounted in any known manner. Preferably, in the example represented in the figures, pump 20 is mounted on container 10 in a nonremovable manner by means of snappable ring fastener 25, advantageously with interposing of seal 26 between the open end of container 10 and the flange of pump 20. This mode of fastening, snapping, is the most economical because it does not require complicated and expensive equipment to produce it, contrary to other types of fastening such as crimping, for example.

Preferably, the container is a cylinder closed on one side by a bottom wall and on the other side by the pump. Thus, any risk of leakage is eliminated, in particular if the fastening is done in a sealed manner.

The device of the invention also has thruster 30 which has a distribution opening and which makes it possible to actuate the pump and thus to distribute selectively the product held in container 10.

Preferably, as represented in FIG. 2, the device has cap 50 making it possible to close the device between successive uses. This cap 50, in closed position, prevents access to thruster 30 and therefore any accidental actuation of pump 20.

According to the invention, container 10 has, on the outside, sheath 40 made of plastic material which is preferably cylindrical and closed on one side by a bottom wall. This sheath or tube made of plastic preferably extends over the whole exterior surface of container 10 and is in particular mounted by inserting container 10 inside of sheath 40. In order to facilitate this operation, said sheath 40 can have, in its bottom wall, a small air escape opening 45 making it possible for air to escape during insertion of container 10 in sheath 40.

As mentioned in the preceding, the invention applies quite particularly to perfume samples. Container 10 is therefore produced out of glass, but it could also be produced out of another material which is inert to the product and which does not react with it even in case of long duration storage.

The presence of sheath 40 around container 10 provides the following advantages:

1/ Sheath 40 can be produced out of any colored and/or printed plastic so that in order to make the device distinctive to the public, it is not necessary to generate extra cost in the manufacturing of said device as is the case when one wishes to lacquer a glass container.

2/ The plastic sheath allows the use of any color and any type of inscription, also with no extra cost, which is a certain advantage for the producer of the product contained in the device, in particular when the distinctive mark contains such special colors which cannot be used in case of lacquering of glass.

3/ The printing and/or decoration of the plastic sheath, for example, by the screen process or hot marking, is facilitated in comparison with the system in which the container is itself made of a plastic material. In effect, the presence of the glass container inside of the plastic sheath makes it possible to stiffen the whole and thus allows one to do the above-mentioned operation very easily and inexpensively.

4/ The device thus obtained, with its exterior appearance, is not altered or modified by long storage of the product inside the container, because of the use of a material inert to the product, for producing the container which holds the product.

1. A liquid perfume sample which has product container (10), pump (20) and thruster (30), characterized by the fact that container (10) is produced out of glass, and by the fact that said container (10) has sheath (40) made of plastic material on the outside.

2. A sample according to claim 1, in which said container (10) is a cylinder closed on one side and which, on the other side and in a sealed manner, holds pump (20) by means of snappable ring fastener (25).

3. A sample according to claim 1 or 2, which moreover has closing cap (50) which, in closed position, prevents actuation of pump (20).

4. A sample according to any one of the preceding claims, in which sheath (40) is a cylinder closed on one side by a bottom wall.

5. A sample according to any one of the preceding claims, in which plastic sheath (40) extends over the whole exterior surface of container (10).

6. A sample according to any one of the preceding claims, in which said container (10) is inserted in said sheath (40) which preferably has air escape opening (46) in its bottom wall in order to facilitate said insertion.

7. A sample according to any one of the preceding claims, in which pump (20) is mounted on the container in a nonremovable manner by means of snappable ring fastener (25).

8. A sample according to any one of the preceding claims, in which plastic sheath (40) can be of any desired coloration and/or printed with any desired distinctive marks.
